(19) United States
(12) Patent Application Publication
(10) Pub. No.: US 2026/0135614 A1
(43) Pub. Date: May 14, 2026

(54) SATELLITE NETWORK CONSTRUCTION METHOD AND APPARATUS, MEDIUM, AND DEVICE

(71) Applicant: ZHEJIANG LAB, Hangzhou (CN)

(72) Inventors: Chao Li, Hangzhou (CN); Changkuan Chen, Hangzhou (CN); Hui Zhang, Hangzhou (CN); Hao Zheng, Hangzhou (CN); Yaguang Zhu, Hangzhou (CN); Zhi Wang, Hangzhou (CN); Luqi Gong, Hangzhou (CN); Kelu Yao, Hangzhou (CN); Xu Li, Hangzhou (CN)

(21) Appl. No.: 19/234,262

(22) Filed: Jun. 10, 2025

Related U.S. Application Data
(63) Continuation-in-part of application No. PCT/CN2024/138288, filed on Dec. 10, 2024.

(30) Foreign Application Priority Data
Nov. 8, 2024 (CN) 202411594180.0

(51) Int. Cl. H04B 7/185

(52) U.S. Cl. CPC H04B 7/18521

(57) ABSTRACT

Provided are a satellite network construction method and apparatus, a medium, and a device. For a satellite in a satellite cluster, candidate satellites of the satellite are determined based on orbit data of the satellite, and communication quality between the satellite and the candidate satellites within first time in the future is predicted. Based on the predicted communication quality, a resource quantity of each of the candidate satellites, and the orbit data, networking satellites matching the satellite are determined from the candidate satellites to construct a satellite network of the satellite. A to-be-executed distributed task is executed in the satellite cluster in units of the satellite network. Another satellites with good quality of communication with the satellite are determined as the networking satellites of the satellite to construct the satellite network of the satellite. Then, the distributed task is executed in units of the satellite network.

### CROSS REFERENCE TO RELATED APPLICATIONS

The present application is a Continuation-In-Part Application of PCT Application No. PCT/CN2024/138288 filed on Dec. 10, 2024, which claims the benefit of Chinese Patent Application No. 202411594180.0 filed on Nov. 8, 2024. All the above are hereby incorporated by reference in their entirety.

### TECHNICAL FIELD

The present disclosure relates to the field of satellite cloud computing, and in particular, to a satellite network construction method and apparatus, a medium, and a device.

### BACKGROUND

With the development of satellite technologies and cloud computing, promoting integration of a satellite, a ground, and a cloud computing center, and utilizing characteristics of wide coverage and strong disaster resistance of the satellite, and constructing a space-ground integrated network and application architecture have become an important direction for current development. The cloud computing center has a high demand for computing power resources, energy, and the like. Therefore, the cloud computing center is often deployed on the ground. When the satellite needs to invoke computing power of the cloud computing center to execute a task, data required to execute the task needs to be transmitted to the ground. The cloud computing center deployed on the ground executes the task based on the data, and then returns task data to the satellite.

In the prior art, in order to solve a problem that there is a large delay in executing the task of the satellite because the cloud computing center is far away from a data source, an edge computing technology is usually applied in a satellite cluster, that is, an application for executing the task is deployed on the satellite through an edge computing platform such as KubeEdge, and a computing resource used by the satellite to execute the task is provided on the satellite, such that a satellite in the satellite cluster can execute the task between satellites.

However, inter-satellite data transmission focuses on radio wave and laser communication. Due to a harsh environment in space, such as multipath fading and solar activities, an inter-satellite communication link has a high error rate or is unable to perform communication, which in turn affects efficiency of executing an inter-satellite distributed task. Therefore, how, and constructing an inter-satellite satellite network to reduce an impact of communication quality on task execution efficiency has become an urgent problem to be solved.

### SUMMARY

The present disclosure provides a satellite network construction method and apparatus, a medium, and a device, to partially solve the above problems in the prior art.

The present disclosure adopts the following technical solutions:

A satellite network construction method, wherein the satellite network construction method is applied to a ground management platform, and includes:
for a satellite in a satellite cluster, determining, based on orbit data of the satellite, other satellites capable of communicating with the satellite within first time in the future as candidate satellites of the satellite, and predicting communication quality between the satellite and the candidate satellites within the first time in the future;
determining, from the candidate satellites based on the predicted communication quality, a resource quantity of each of the candidate satellites, and the orbit data, networking satellites matching the satellite within the first time in the future, and constructing a satellite network of the satellite; and
sending the satellite network of the satellite to the satellite, whereby the satellite executes a distributed task in units of the satellite network.

Optionally, the determining, from the candidate satellites based on the predicted communication quality, a resource quantity of each of the candidate satellites, and the orbit data, networking satellites matching the satellite within the first time in the future specifically includes:
determining candidate links from links between the candidate satellites and the satellite based on the orbit data, and determining corresponding pheromone concentrations of the candidate links;
constructing, starting from the satellite, each satellite network of the satellite based on the corresponding pheromone concentrations of the candidate links, determining quality of each path, and adjusting the corresponding pheromone concentrations of the candidate links based on the determined quality of each path; and
after a preset quantity of rounds of adjustments, determining quality of each path in a current round, and determining the networking satellite of the satellite based on the quality of each path.

Optionally, the adjusting the corresponding pheromone concentrations of the candidate links based on the determined quality of each path specifically includes:
sorting each path based on the determined quality of each path to determine a first sequence;
determining a corresponding pheromone concentration of each path based on the corresponding pheromone concentrations of the candidate links in each path, and sorting each path based on each pheromone concentration to determine a second sequence; and
adjusting a weighted weight between the predicted communication quality, the resource quantity of each of the candidate satellites, and the orbit data with a goal of minimizing a difference between the first sequence and the second sequence, and updating the corresponding pheromone concentrations of the candidate links.

Optionally, the determining candidate links from links between the candidate satellites and the satellite based on the orbit data specifically includes:
determining evaluation scores of the links between the candidate satellites and the satellite based on the predicted communication quality, the resource quantity of each of the candidate satellites, and the orbit data; and
selecting a link whose evaluation score reaches a preset value as a candidate link.

Optionally, the determining, based on orbit data of the satellite, other satellites capable of communicating with the satellite within first time in the future as candidate satellites of the satellite specifically includes:
determining communicable satellites of the satellite based on the orbit data of the satellite; and
determining, based on communicable time periods of the communicable satellites, communicable satellites whose communication time periods overlap with a communication time period of the satellite within the first time in the future as candidate satellites of the satellite; and
the determining, from the candidate satellites, networking satellites matching the satellite within the first time in the future, and constructing a satellite network of the satellite specifically includes:
determining, based on overlapping time periods between the satellite and the candidate satellites, networking satellites matching the satellite at each time point within the first time, and constructing a satellite network of the satellite at each time point within the first time.

Optionally, the determining, from the candidate satellites, networking satellites matching the satellite within the first time in the future specifically includes:
determining a quantity of communication terminals of the satellite; and
determining, from the candidate satellites, satellites whose quantity is not greater than the quantity of communication terminals as networking satellites of the satellite.

Optionally, the sending the satellite network of the satellite to the satellite specifically includes:
determining a satellite capable of communicating with the ground management platform at a current time point; and
sending each determined satellite network to the satellite capable of communicating with the ground management platform at the current time point, such that the satellite capable of communicating with the ground management platform at the current time point performs inter-satellite synchronization on each satellite network.

The present disclosure provides a satellite network construction apparatus, wherein the satellite network construction apparatus is disposed on a ground management platform, and includes:
a prediction module configured to: for a satellite in a satellite cluster, determine, based on orbit data of the satellite, other satellites capable of communicating with the satellite within first time in the future as candidate satellites of the satellite, and predict communication quality between the satellite and the candidate satellites within the first time in the future;
a construction module configured to determine, from the candidate satellites based on the predicted communication quality, a resource quantity of each of the candidate satellites, and the orbit data, networking satellites matching the satellite within the first time in the future, and construct a satellite network of the satellite; and
a sending module configured to send the satellite network of the satellite to the satellite, such that the satellite executes a distributed task in units of the satellite network.

The present disclosure provides a computer-readable storage medium, storing a computer program, where the computer program is executed by a processor to implement the satellite network construction method described above.

The present disclosure provides an electronic device, including a memory, a processor, and a computer program stored in the memory and executable on the processor, where the processor executes the computer program to implement the satellite network construction method described above.

At least one of the foregoing technical solutions adopted in the present disclosure can achieve the following beneficial effects:
In the satellite network construction method of the present disclosure, for a satellite in a satellite cluster, candidate satellites of the satellite are determined based on orbit data of the satellite, and communication quality between the satellite and the candidate satellites within first time in the future is predicted. Based on the predicted communication quality, a resource quantity of each of the candidate satellites, and the orbit data, a networking satellite matching the satellite is determined from the candidate satellites to construct a satellite network of the satellite. A to-be-executed distributed task is executed in the satellite cluster in units of the satellite network.

From the above method, it can be seen that another satellite with good quality of communication with the satellite is determined as the corresponding networking satellite of the satellite to construct the satellite network of the satellite. Then, the distributed task is executed in units of the satellite network, thereby improving efficiency and quality of executing the distributed task and reducing an impact of an inter-satellite environment on the execution of the distributed task.

### BRIEF DESCRIPTION OF THE DRAWINGS

The accompanying drawings described herein are provided for further understanding of the present disclosure, and constitute a part of the present disclosure. The exemplary embodiments of the present disclosure and illustrations thereof are intended to explain the present disclosure, but do not constitute inappropriate limitations to the present disclosure. In the accompanying drawings:

FIG. 1 is a schematic diagram of a data processing procedure of a satellite in the prior art;

FIG. 2 is a schematic diagram of a satellite network construction method according to the present disclosure;

FIG. 3 is a schematic diagram of a sending procedure of satellite network construction according to the present disclosure;

FIG. 4 is a schematic diagram of a satellite network according to the present disclosure;

FIG. 5 is a schematic diagram of a satellite network construction apparatus according to the present disclosure; and

FIG. 6 is a schematic diagram of an electronic device corresponding to FIG. 2 according to the present disclosure.

### DETAILED DESCRIPTION

To make the objective, technical solutions, and advantages of the present disclosure clearer, the technical solutions in the present disclosure are clearly and completely described below with reference to specific embodiments and corresponding accompanying drawings of the present disclosure. Apparently, the described embodiments are some rather than all of the embodiments of the present disclosure. All other embodiments obtained by those skilled in the art based on the embodiments of the present disclosure without creative efforts shall fall within the protection scope of the present disclosure.

The technical solutions provided in the embodiments of the present disclosure are described in detail below with reference to the accompanying drawings.

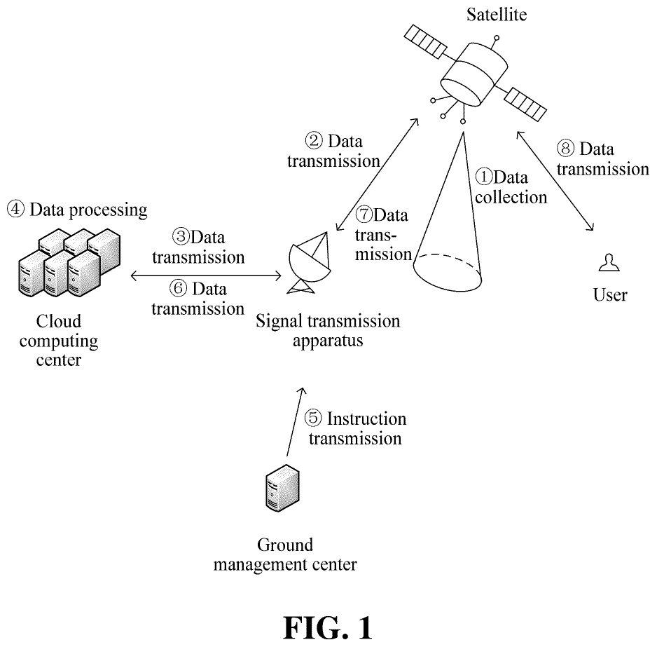

With the development of satellite technologies, a satellite provides important support and supplementation for ground communication due to its global coverage, flexible deployment, and strong resistance to a natural disaster. With the development of cloud computing, a cloud computing center can also provide a universal and powerful computing power resource for different applications, supplementing shortcomings of satellite resources borne on the satellite, such as a computing power resource, a network resource, and a network bandwidth. Therefore, promoting integration of the satellite, a ground, and the cloud computing center, and constructing a space-ground integrated network and application architecture have become an important direction for current development. However, in order to achieve the powerful computing power resource, the cloud computing center also has a high demand for energy, equipment, and the like. Therefore, the cloud computing center is often deployed on the ground, and data generated by the satellite is transmitted back to the cloud computing center on the ground for processing. After processing the data, the cloud computing center on the ground returns a processing result to the satellite. FIG. 1 is a schematic diagram of a data processing procedure of a satellite in the prior art. As shown in FIG. 1, the satellite returns collected data to a signal reception apparatus on a ground, and then a signal transmission apparatus transmits the data to a cloud computing center disposed on the ground. Then the cloud computing center receives a control instruction of a ground management platform and returns the data to the satellite through the signal transmission apparatus, and the satellite returns the data to a user.

However, the cloud computing center is far away from the satellite, and a data transmission process is long, which results in a high data processing latency and a significant network bandwidth overhead. Therefore, an edge computing technology is currently used to solve a problem of a large computing latency caused by a long distance. That is, a space-based edge computing system is constructed based on the ground management platform, the cloud computing center, and a satellite cluster, and computing resources are deployed in a place nearest to a place where data is generated. For example, some applications used for task execution are run in a satellite-borne computing unit, such that the satellite can process data in orbit, so as to execute a task with a low latency, and further reduce occupation of network resources between the satellite and the ground.

However, there is usually a dependency relationship between distributed tasks, and satellites in the satellite cluster move relative to each other due to their different orbits. If satellites executing a same distributed task change their relative positions, the satellites executing the same distributed task are unable to communicate with each other due to a long distance or obstruction, which affects efficiency and accuracy of executing the distributed task. An inter-satellite satellite network can be constructed to execute the distributed task in units of the satellite network. However, inter-satellite data transmission focuses on radio wave and laser communication. Due to a harsh environment in space, such as multipath fading and solar activities, an inter-satellite communication link has a high error rate and poor communication quality. When communication between satellites with a dependency relationship is poor, efficiency of executing an inter-satellite distributed task is affected. Therefore, how to construct the inter-satellite satellite network to reduce an impact of communication quality on task execution efficiency has become an urgent problem to be solved.

It should be noted that in one or more embodiments of the present disclosure, the satellite network is a local area network formed by the satellites in the satellite cluster through networking, and all other satellites than the satellite in the local area network are networking satellites of the satellite. In addition, due to a large quantity of satellites in the satellite cluster, a quantity of satellite networks constructed for each satellite is also relatively large. Satellite resources are relatively precious. In order to reduce the waste of the satellite resources, a satellite network construction task is usually carried out by the ground management platform. Each constructed satellite network is sent to the satellite. Certainly, when there is a lot of idle inter-satellite computing resources, in order to improve efficiency of satellite network construction, the satellite network construction method described in the embodiments of the present disclosure can also be executed by a satellite-borne server. For ease of description, description is provided subsequently by using an example in which the satellite network construction method is executed by the ground management platform.

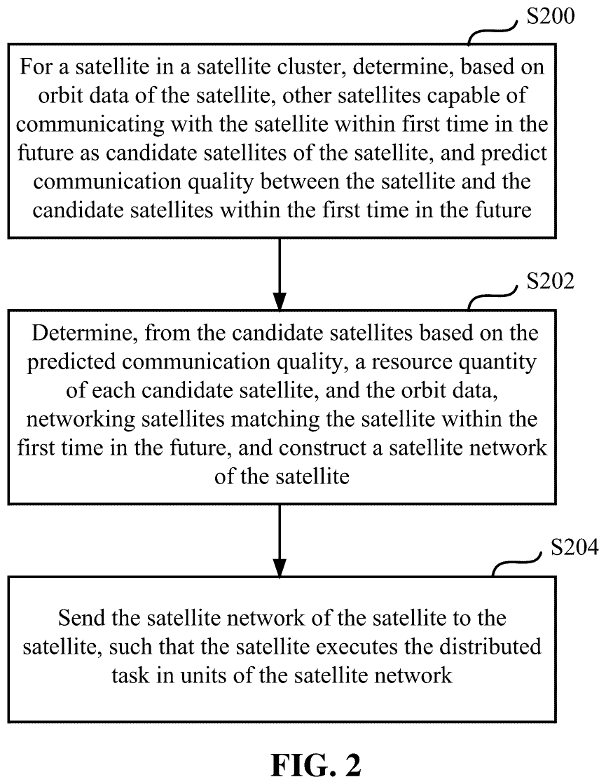

FIG. 2 is a schematic diagram of a satellite network construction method according to the present disclosure. Specific steps are as follows:
S200: For a satellite in a satellite cluster, determine, based on orbit data of the satellite, other satellites capable of communicating with the satellite within first time in the future as candidate satellites of the satellite, and predict communication quality between the satellite and the candidate satellites within the first time in the future.

In one or more embodiments of the present disclosure, a specific device for executing the satellite network construction method is not limited, and for example, may be a mobile terminal or a server. However, since subsequent steps involve model training, satellite status data analysis, and other operations that have a high requirement for computing resources and require high permissions, these operations are generally executed by the server. Certainly, the specific device for executing the satellite network construction method also depends on a device specifically adopted for a ground management platform. The present disclosure is subsequently described by using an example in which the server executes the satellite network construction method. The server may be a single device or composed of a plurality of devices, such as a distributed server. This is not limited in the present disclosure.

In order to construct a satellite network with good inter-satellite communication quality, the server can select, from the satellite cluster, another satellite that has good quality of communication with the satellite to construct the satellite network. In order to reduce time and resources required for the server to predict the communication quality, for the satellite in the satellite cluster, the server can also determine, from the satellite cluster, another satellite that can directly communicate with the satellite as a candidate satellite, and then predict the communication quality between the satellite and the candidate satellites.

Specifically, for the satellite in the satellite cluster, the server determines, based on the orbit data of the satellite, the other satellites capable of communicating with the satellite within the first time in the future as the candidate satellites of the satellite. That is, a motion trajectory of the satellite in space within the first time in the future is determined based on the orbit data of the satellite, and therefore, the another satellite that can directly communicate with the satellite is determined as the candidate satellite of the satellite. The orbit data of the satellite at least includes an altitude of an orbit in which the satellite is located, current coordinates of the satellite, and the like.

Then the server predicts the communication quality between the satellite and the candidate satellites within the first time in the future based on the orbit data of the satellite and communication data between the satellite and the candidate satellites. That is, communication distances, environmental conditions, and the like between the satellite and the candidate satellites within the first time in the future are determined based on the orbit data of the satellite. Then, the communication quality between the satellite and the candidate satellites within the first time in the future is determined based on the communication data between the satellite and the candidate satellites. The communication data at least includes communication methods, signal frequencies, encryption methods, communication bandwidths, network resources, and the like used between the satellite and the candidate satellites.

It should be noted that in one or more embodiments of the present disclosure, a specific method used by the server to determine the communication quality between the satellite and the candidate satellites is not limited. The communication quality may be predicted through a trained evaluation model, or the communication quality between the satellite and the candidate satellites may be evaluated by performing weighted calculation on the communication distances, the environmental data, the communication data, the communication bandwidths, and other data between the satellite and the candidate satellites.

It should be noted that the predicted communication quality may be average communication quality between the candidate satellites and the satellite within the first time in the future, or a change trend of the communication quality between the candidate satellites and the satellite.

Certainly, in one or more embodiments of the present disclosure, how the server specifically determines the first time is not limited, either. The first time may be preset duration such as 24 hours or 12 hours, may be determined based on an earth orbiting cycle of the satellite, or may be determined based on power-on duration of the satellite. The first time is not limited in the present disclosure, and may be set based on actual needs.

In addition, in one or more embodiments of the present disclosure, since the orbit data of the satellite is fixed, the server can obtain the orbit data of the satellite without communicating with the satellite. However, when the communication data between the satellite and the candidate satellites is determined, communication data between the satellite in the satellite cluster and other satellites may be directly synchronized to the ground management platform when the satellite communicates with the ground management platform, or a request for obtaining communication data between the satellite and other satellites may be sent to a communicable satellite when the ground management platform needs to construct the satellite network, to obtain the communication data between the satellite in the satellite cluster and the other satellites. In addition, the server can also obtain the communication data between the satellite in the satellite cluster and the other satellites at regular intervals. When the satellite network needs to be constructed, previously obtained communication data between the satellite and the other satellites can be used as communication data required for constructing the satellite network. A specific method is not limited in the present disclosure, and may be set based on actual needs.

It should be noted that data of the satellite is shared among all satellites in the satellite cluster, including the communication data between the satellite and the other satellites and other data. That is, the ground management platform can also obtain the data of the satellite in the satellite cluster even when communicating with only one satellite.
S202: Determine, from the candidate satellites based on the predicted communication quality, a resource quantity of each candidate satellite, and the orbit data, networking satellites matching the satellite within the first time in the future, and construct a satellite network of the satellite.

After the communication quality is predicted, in order to improve efficiency of the constructed satellite network and inter-satellite task execution efficiency, the server can use candidate satellites with high communication quality determined in the step S200 as the networking satellites of the satellite. In this way, the satellite network can efficiently execute a distributed task within the first time, and the task execution by the satellite network is less affected by a space environment within the first time.

Specifically, the server scores each candidate satellite based on the determined communication quality, the resource quantity of each candidate satellite, and the orbit data. Then, based on a score of each candidate satellite, candidate satellites with high scores are determined as the networking satellites matching the satellite within the first time in the future, and the satellite network of the satellite is constructed based on the satellite and the networking satellites of the satellite.

It should be noted that the resource quantity of each candidate satellite is the types and quantities of computing power resource, the rates and quantities of network resource, the bandwidth margins of bandwidth resource, and quantities of other satellite resources contained respectively in each candidate satellite, rather than a total resource quantity contained in each candidate satellite.
S204: Send the satellite network of the satellite to the satellite, such that the satellite executes the distributed task in units of the satellite network.

After the corresponding satellite network of the satellite is determined, in order to enable the satellite to perform task execution based on the determined satellite network, the server can also send each satellite network to the satellite.

Specifically, the server can determine a communicable satellite at a current time point, and then send each determined satellite network to the communicable satellite, such that the communicable satellite performs inter-satellite synchronization on each satellite network sent by the server, constructs each satellite network, and executes the distributed task in units of the satellite network.

It should be noted that in one or more embodiments of the present disclosure, a quantity of communicable satellites to which the server sends each satellite network is not limited. The server may send each determined satellite network to each communicable satellite, or send each satellite network to one communicable satellite, that is, determine a satellite communicating with the ground management platform at the current time point as a window satellite, and send each satellite network to the window satellite, such that the window satellite synchronizes each satellite network to other satellites in the satellite cluster. Certainly, a specific task that each satellite network executes is not limited. The distributed task may be executed, other types of businesses may be executed directly, or a plurality of tasks may be performed simultaneously. This is not limited in the present disclosure.

In addition, the satellite network determined by the server is the corresponding satellite network of the satellite in the satellite cluster, rather than a satellite network divided from the satellite cluster. That is, the server can determine the satellite network and each networking satellite for the satellite, and the satellite can also serve as a networking satellite of other satellites excluding the satellite in the satellite cluster.

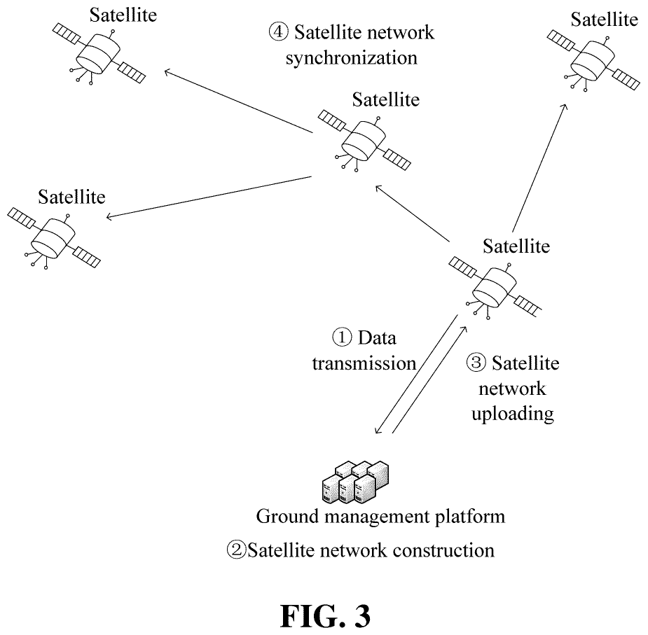

FIG. 3 is a schematic diagram of a sending procedure of satellite network construction according to the present disclosure. As shown in FIG. 3, the ground management center obtains status data of the satellite in the satellite cluster through a currently communicating satellite, constructs the satellite network of the satellite based on the status data, and then sends the satellite network of the satellite to the currently communicating satellite, such that the currently communicating satellite performs the inter-satellite synchronization on the satellite network of the satellite.

In the satellite network construction method based on FIG. 2, for the satellite in the satellite cluster, the candidate satellites of the satellite are determined based on the orbit data of the satellite, and the communication quality between the satellite and the candidate satellites within the first time in the future is predicted. Based on the predicted communication quality, the resource quantity of each candidate satellite, and the orbit data, the networking satellites matching the satellite are determined from the candidate satellites to construct the satellite network of the satellite. The to-be-executed distributed task is executed in the satellite cluster in units of the satellite network.

From the above method, it can be seen that the another satellites that have good quality of communication with the satellite are determined as the corresponding networking satellites of the satellite to construct the satellite network of the satellite. Then, the distributed task is executed in units of the satellite network, thereby improving efficiency and quality of executing the distributed task and reducing an impact of an inter-satellite environment on the execution of the distributed task.

In addition, in the step S200, since not all satellites in the satellite cluster can perform communication directly, in order to ensure efficiency of executing the distributed task by a satellite in the satellite network, each satellite in the satellite network constructed by the server should be a directly communicable satellite.

It should be noted that when there are many directly communicable satellites of the satellite, in one or more embodiments of the present disclosure, the server can also screen each directly communicable satellite based on a distance between each directly communicable satellite and the satellite, and determine a directly communicable satellite that is of the satellite and whose distance from the satellite is less than a preset value as the candidate satellite. Certainly, the server can also screen the candidate satellites of the satellite by using another method. For example, the server inputs the communication data of the satellite and communication data of each directly communicable satellite into a trained scoring model, scores each directly communicable satellite, and selects a communicable satellite whose score exceeds a preset score as the candidate satellite. Each communicable satellite can also be screened by using another method. However, there are many methods available, and details are not described herein.

Further, the above trained scoring model can be obtained through training by means of reinforcement learning. That is, a speed of determining the satellite network is used as a reward. A higher speed leads to a higher reward, and thus, the scoring model is trained.

In addition, in one or more embodiments of the present disclosure, a specific method used by the server to determine the communication quality between the candidate satellites and the satellite is not limited. For example, bit error rates and other information between the candidate satellites and the satellite are scored, and scores are used as the communication quality between the candidate satellites and the satellite. The communication quality between the candidate satellites and the satellite can also be determined by using another method, which is not limited in the present disclosure.

In addition, due to a short communicable time period between the satellite and the ground management platform, the server of the ground management platform should construct the satellite network as quickly as possible for the satellite. However, because there are often lots of satellites in the satellite cluster, there are also many satellite networks that need to be constructed. As a result, the server needs to take a long time to construct satellite networks of the satellites. Therefore, in order to improve efficiency of constructing the satellite network, the server can also use an ant colony algorithm to enhance its parallel capability in executing satellite network construction tasks.

Specifically, candidate links are determined from links between the candidate satellites and the satellite based on the orbit data, and corresponding pheromone concentrations of the candidate links are determined. Starting from the satellite, each satellite network of the satellite is constructed based on the corresponding pheromone concentrations of the candidate links, quality of each path is determined, and the corresponding pheromone concentrations of the candidate links are adjusted based on the determined quality of each path. After a preset quantity of rounds of adjustments, quality of each path in a current round is determined, and the networking satellite of the satellite is determined based on the quality of each path.

It should be noted that in one or more embodiments of the present disclosure, a specific method used by the server to determine the quality of each path is not limited. An average value of the corresponding pheromone concentrations of the candidate links in each path may be used as the quality of the path, or average values of communication data, communication distances, and other data of the candidate links in each path are weighted as the quality of the path. The specific method may be set based on actual needs.

In addition, when determining the corresponding pheromone concentrations of the candidate links, the server can weight the predicted communication quality, the resource quantity of each candidate satellite, and the orbit data, and use weighted results as the corresponding pheromone concentrations of the candidate links. Alternatively, historical task execution efficiency of the candidate satellites may be used as the pheromone concentrations. Alternatively, the server may weight historical task execution efficiency of the candidate satellites and communication quality of the candidate satellites, and use weighted results as the pheromone concentrations. In one or more embodiments of the present disclosure, a key feature of the ant colony algorithm, namely the pheromone concentration, is used, which is not limited in the present disclosure and can be set based on actual needs.

Then, when adjusting the pheromone concentrations, the server can sort each path based on the determined quality of each path to determine a first sequence. Then, a corresponding pheromone concentration of each path is determined based on the corresponding pheromone concentrations of the candidate links in each path, and each path is sorted based on each pheromone concentration to determine a second sequence. Finally, parameters of a preset pheromone concentration calculation formula are adjusted with a goal of minimizing a difference between the first sequence and second sequence, and the corresponding pheromone concentrations of the candidate links are updated.

Certainly, the server can also adjust the parameters of the preset pheromone concentration calculation formula through a trained pheromone update model, which replaces manual adjustment of the parameters.

Further, in order to increase a speed of determining the networking satellite, the server can determine evaluation scores of the links between the candidate satellites and the satellite based on the predicted communication quality, the resource quantity of each candidate satellite, and the orbit data, and use a link whose evaluation score reaches a preset value as the candidate link. This reduces pheromone concentration calculations and path selections.

It should be noted that when determining the evaluation scores of the links between the candidate satellites and the satellite, the server can determine distances and environmental information between the candidate satellites and the satellite based on the orbit data. The distance is negatively correlated with the evaluation score, the environmental information is positively correlated with the evaluation score, a resource chain of the candidate satellite is positively correlated with the evaluation score, and the communication quality is positively correlated with the evaluation score.

In addition, because communication time between the ground management platform and the satellite is limited, and the satellites often move relative to each other at different altitudes in the space, the satellite network should also be different in different time periods. In addition, power-on time of different satellites is also different. That is, when a distance between two satellites is appropriate, if power-on time of the two satellites is different, the two satellites may not be able to communicate with each other, or a communicable time period may be shorter than first duration. Therefore, the server can also determine each satellite network within the first time for the satellite. In this way, the satellite can always form a satellite network and execute the distributed task.

Specifically, the server determines a communicable satellite of the satellite based on the orbit data of the satellite. Then a communicable time period of each communicable satellite is determined. Based on the orbit data and a communicable time period of the satellite, a communicable satellite whose communication time period overlaps with a communication time period of the satellite within the first time in the future is determined as the candidate satellite of the satellite. Then a networking satellite matching the satellite at each time point within the first time is determined based on overlapping time periods between the satellite and the candidate satellites to construct a satellite network of the satellite at each time point within the first time. In this way, the satellite can update its own satellite network based on each determined satellite network during disconnection from the ground management platform, and always execute the distributed task based on a satellite network with an optimal path within the first time.

For example, if power-on time periods of the satellite within 24 hours are 8:00 to 10:00, 15:00 to 19:00, and 20:00 to 24:00, and power-on time periods of a networking satellite A, a networking satellite B, a networking satellite C, and a networking satellite of the satellite are respectively 8:00 to 20:00, 7:00 to 15:00, 15:00 to 24:00, and 19:00 to 22:00, a satellite network formed by the satellite within 8:00 to 10:00 is A-the satellite-B, a satellite network constituted by the satellite within 15:00 to 19:00 is A-the satellite-C, a satellite network constituted by the satellite within 20:00 to 22:00 is C-the satellite-D, and a satellite network constituted by the satellite within 22:00 to 24:00 is C-the satellite.

It should be noted that in one or more embodiments of the present disclosure, the communicable satellite is a satellite that can perform communication without obstruction between two satellites. The communicable time period is a time period during which two satellites are simultaneously powered on and communicable. When determining the pheromone concentrations of the candidate links, the server may also use duration of the overlapping time period as a part of determining the pheromone concentration. Alternatively, a candidate satellite with the overlapping time period less than preset duration can be removed from the candidate satellites.

In addition, many satellites can communicate with the satellite, but a quantity of communication terminals of each satellite is limited. Although the satellite can also communicate with a plurality of satellites by rotating the communication terminal, time required to adjust an angle of the communication terminal can also lead to a high latency in executing the distributed task. Therefore, when determining the satellite network of the satellite, the quantity of communication terminals of the satellite should also be considered.

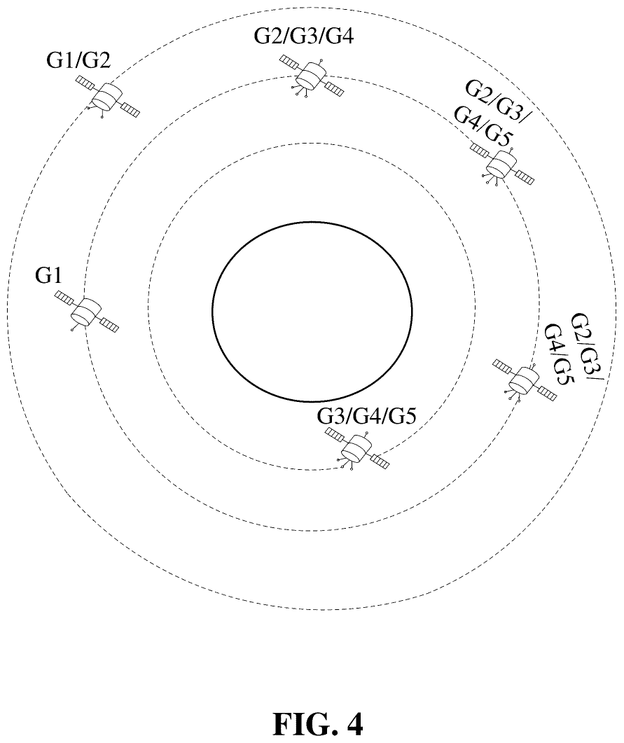

Specifically, the server determines the quantity of communication terminals of the satellite, and then determines a target quantity of networking satellites when determining the networking satellite of the satellite from the candidate satellites, where the target quantity is not greater than the quantity of communication terminals of the satellite. FIG. 4 is a schematic diagram of a satellite network according to the present disclosure. As shown in FIG. 4, a middle circle represents the Earth, and three rings represent three orbits around the Earth. Satellites in a satellite cluster orbit around the Earth on the three orbits. Each small circle on each satellite represents a communication terminal of the satellite. Each satellite has a different quantity of communication terminals, and satellites with a same identification form a satellite network.

In addition, in one or more embodiments of the present disclosure, there is no limitation on how the server specifically determines which distributed task should be executed by each satellite network. The determined distributed task may be directly sent to the satellite for inter-satellite task allocation, or the server may determine how to allocate the distributed task based on remaining satellite resources within each satellite network, such as a computing power resource and a network resource. A specific method may be set based on actual needs.

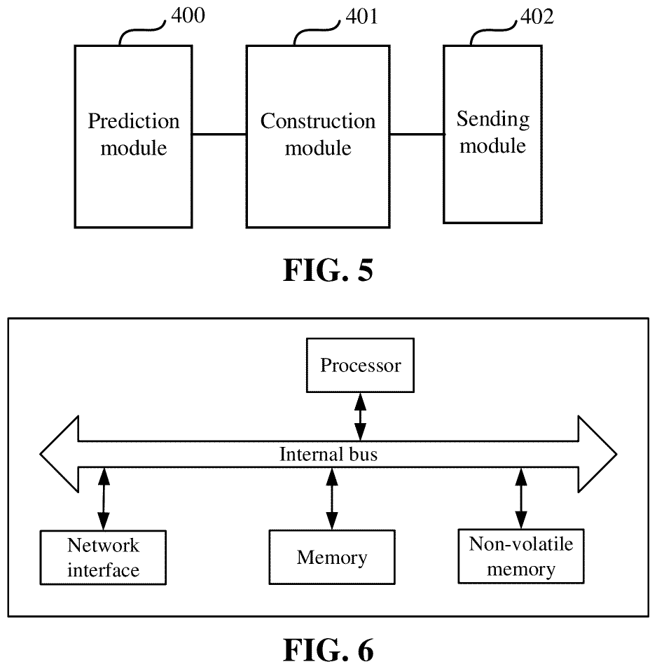

The above is the satellite network construction method provided in the embodiments of the present disclosure. Based on a same concept, the present disclosure further provides a corresponding satellite network construction apparatus, as shown in FIG. 5.

A prediction module 400 is configured to: for a satellite in a satellite cluster, determine, based on orbit data of the satellite, other satellites capable of communicating with the satellite within first time in the future as candidate satellites of the satellite, and predict communication quality between the satellite and the candidate satellites within the first time in the future.

A construction module 401 is configured to determine, from the candidate satellites based on the predicted communication quality, a resource quantity of each candidate satellite, and the orbit data, networking satellites matching the satellite within the first time in the future, and construct a satellite network of the satellite.

A sending module 402 is configured to send the satellite network of the satellite to the satellite, such that the satellite executes a distributed task in units of the satellite network.

Optionally, the construction module 401 is configured to: determine candidate links from links between the candidate satellites and the satellite based on the orbit data, and determine corresponding pheromone concentrations of the candidate links; construct, starting from the satellite, each satellite network of the satellite based on the corresponding pheromone concentrations of the candidate links, determine quality of each path, and adjust the corresponding pheromone concentrations of the candidate links based on the determined quality of each path; and after a preset quantity of rounds of adjustments, determine quality of each path in a current round, and determine the networking satellite of the satellite based on the quality of each path.

Optionally, the construction module 401 is configured to: sort each path based on the determined quality of each path to determine a first sequence; determine a corresponding pheromone concentration of each path based on the corresponding pheromone concentrations of the candidate links in each path, and sort each path based on each pheromone concentration to determine a second sequence; and adjust parameters of a preset pheromone concentration calculation formula with a goal of minimizing a difference between the first sequence and the second sequence, and update the corresponding pheromone concentrations of the candidate links.

Optionally, the construction module 401 is configured to: determine evaluation scores of the links between the candidate satellites and the satellite based on the predicted communication quality, the resource quantity of each candidate satellite, and the orbit data; and select a link whose evaluation score reaches a preset value as a candidate link.

Optionally, the prediction module 400 is configured to: determine communicable satellites of the satellite based on the orbit data of the satellite; and determine, based on communicable time periods of the communicable satellites, communicable satellites whose communication time periods overlap with a communication time period of the satellite within the first time in the future as candidate satellites of the satellite. The construction module 401 is configured to: determine, based on overlapping time periods between the satellite and the candidate satellites, networking satellites matching the satellite at each time point within the first time and construct a satellite network of the satellite at each time point within the first time.

Optionally, the construction module 401 is configured to determine a quantity of communication terminals of the satellite; and determine, from the candidate satellites, satellites whose quantity is not greater than the quantity of communication terminals as networking satellites of the satellite.

Optionally, the sending module 402 is configured to determine a satellite capable of communicating with the ground management platform at a current time point; and send each determined satellite network to the satellite capable of communicating with the ground management platform at the current time point, such that the satellite capable of communicating with the ground management platform at the current time point performs inter-satellite synchronization on each satellite network.

In the embodiments of the present disclosure, the prediction module 400, the construction module 401, and the sending module 402 each may be one or more processors or chips that each have a communication interface, can realize a communication protocol, and may further include a memory, a related interface and system transmission bus, and the like if necessary. The processor or chip executes program-related code to realize a corresponding function. Alternatively, the prediction module 400, the construction module 401, and the sending module 402 share an integrated chip or share devices such as a processor and a memory. The shared processor or chip can execute a program-related code to implement a corresponding function.

It should also be noted that the terms “comprise”, “include”, or any other variants thereof are intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The embodiments in the present disclosure are described in a progressive manner. For same or similar parts between the embodiments, reference may be made to each other. Each embodiment focuses on a difference from other embodiments. Particularly, for a system embodiment, since it is basically similar to the method embodiment, the description is relatively simple, and reference can be made to the description of the method embodiment.

The present disclosure further provides a computer-readable storage medium, storing a computer program. The computer program can be configured to execute the satellite network construction method provided in FIG. 2.

The present disclosure further provides a schematic structural diagram of an electronic device shown in FIG. 6. As shown in FIG. 6, in terms of hardware, the electronic device includes a processor, an internal bus, a network interface, a memory, and a non-volatile memory, and certainly, may also include hardware required for other businesses. The processor reads a corresponding computer program from the non-volatile memory into the memory and runs the computer program to implement the satellite network construction method described in FIG. 2. Certainly, besides a software implementation, the present disclosure does not exclude other implementations, such as a logic device or a combination of software and hardware. That is, an execution entity of the following processing procedure is not limited to each logic unit, but may also be hardware or a logic device.

In the 1990s, a technological improvement can be clearly defined as a hardware improvement (for example, an improvement of a circuit structure such as a diode, a transistor, or a switch) or a software improvement (for example, an improvement of a method procedure). However, with the development of technologies, improvements of many method procedures can be regarded as direct improvements of hardware circuit structures. Almost all designers obtain a corresponding hardware circuit structure by programming an improved method procedure into a hardware circuit. Therefore, it is not meant that an improvement of a method procedure cannot be realized by using a hardware entity module. For example, a programmable logic device (PLD) (such as a field programmable gate array (FPGA)) is such an integrated circuit, and its logic function is determined by programming the device by a user. A designer can “integrate” a digital system onto a PLD through programming, without requiring a chip manufacturer to design and manufacture a special integrated circuit chip. Nowadays, this kind of programming replaces manual manufacturing of an integrated circuit chip and is mostly realized by using a “logic compiler”. The logic compiler is similar to a software compiler used to develop and compile a program, and original code before compilation needs to be compiled in a specific programming language that is referred to as a hardware description language (HDL) herein. There are many kinds of HDLs, such as an advanced Boolean expression language (ABEL), an Altera hardware description language (AHDL), Confluence, a Cornell university programming language (CUPL), HDCal, a Java hardware description language (JHDL), Lava, Lola, MyHDL, PALASM, and a Ruby hardware description language (RHDL). At present, a very-high-speed integrated circuit hardware description language (VHDL) and Verilog are most commonly used. It should be understood by a person skilled in the art that a hardware circuit of a logic method procedure can be easily obtained by using the above hardware description languages to perform logic programming on the method procedure and programming the method procedure into an integrated circuit.

A controller may be implemented in any appropriate way. For example, the controller may be a microprocessor or processor, or a computer-readable medium, a logic gate, a switch, an application specific integrated circuit (ASIC), a programmable logic controller or an embedded microcontroller that stores computer-readable program code (such as software or firmware) executable by the microprocessor or processor. For example, the controller includes but is not limited to the following microcontrollers: ARC 625D, Atmel AT91SAM, Microchip PIC18F26K20, and Silicon Labs C8051F320. A memory controller may also be implemented as part of control logic of a memory. Persons skilled in the art are aware that in addition to being realized by using pure computer-readable program code, the controller can realize a same function in a form of the logic gate, the switch, the ASIC, the programmable logic controller, or the embedded microcontroller by performing logic programming on a method step. Therefore, the controller may be considered as a hardware component, and apparatuses for implementing various functions in the controller may also be considered as structures in the hardware component; or even the apparatuses for implementing various functions may be considered as software modules for implementing the method as well as the structures in the hardware component.

The system, apparatus, module or unit described in the foregoing embodiments may be specifically implemented by a computer chip or entity, or implemented by a product with a specific function. One typical implementation device is a computer. Specifically, the computer may be, for example, a personal computer, a laptop computer, a cellular phone, a camera phone, a smartphone, a personal digital assistant, a media player, a navigation device, an E-mail device, a game console, a tablet computer, a wearable device, or a combination thereof.

For ease of description, the foregoing apparatus is divided into various units/modules based on functions for separate description. Certainly, functions of the units/modules may be implemented in one or more pieces of software and/or hardware during implementation of the present disclosure.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on at least one computer-usable storage medium (including but not limited to a magnetic disk memory, a CD-ROM, an optical memory, and the like) that includes computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by the computer or the processor of the another programmable data processing device generate an apparatus for implementing a specific function in one or more processes in the flowcharts and/or in one or more blocks in the block diagrams.

These computer program instructions may also be stored in a computer-readable memory that can guide a computer or another programmable data processing device to work in a specific manner, such that the instructions stored in the computer-readable memory produce an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, such that a series of operations and steps are performed on the computer or the another programmable device to generate computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more central processing units (CPUs), an input/output (I/O) interface, a network interface, and a memory.

The memory may include a non-transitory memory, a random access memory (RAM), and/or a non-volatile memory in a computer-readable medium, such as a read only memory (ROM) or a flash RAM. The memory is an example of the computer-readable medium.

The computer-readable medium includes transitory, non-transitory, removable, and non-removable media, and storage of information may be implemented by any method or technology. The information may be a computer-readable instruction, a data structure, a program module, or other data. Examples of a computer storage medium include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or another memory technology, a compact disc read-only memory (CD-ROM), a digital versatile disk (DVD) or another optical storage device, a magnetic cassette tape, and a magnetic tape disk storage device or another magnetic storage device or any other non-transmission medium, which can be used to store information that can be accessed by a computing device. The computer-readable medium, as defined herein, excludes transitory computer-readable media (transitory media), such as modulated data signals and carrier waves.

It should also be noted that the terms “comprise”, “include”, or any other variants thereof are intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may be in a form of a computer program product that is implemented on at least one computer-usable storage medium (including but not limited to a magnetic disk memory, a CD-ROM, an optical memory, and the like) that includes computer-usable program code.

The present disclosure can be described in general context of a computer-executable instruction, such as a program module, executed by a computer. Generally, the program module includes a routine, a program, an object, a component, a data structure, and the like that performs a specific task or implements a specific abstract data type. The present disclosure can also be practiced in a distributed computing environment where a task is executed by a remote processing device connected through a communication network. In the distributed computing environment, the program module can be located in local and remote computer storage media including storage devices.

The embodiments in the present disclosure are described in a progressive manner. For same or similar parts between the embodiments, reference may be made to each other. Each embodiment focuses on a difference from other embodiments. Particularly, for a system embodiment, since it is basically similar to the method embodiment, the description is relatively simple, and reference can be made to the description of the method embodiment.

The above are merely embodiments of the present disclosure, and are not intended to limit the present disclosure. Various changes and modifications can be made to the present disclosure by those skilled in the art. Any modifications, equivalent replacements, and improvements made within the spirit and principle of the present disclosure should be included within the protection scope of the claims of the present disclosure.

1. A satellite network construction method, wherein the satellite network construction method is applied to a ground management platform, and comprises:
for a satellite in a satellite cluster, determining, based on orbit data of the satellite, other satellites capable of communicating with the satellite within first time in the future as candidate satellites of the satellite, and predicting communication quality between the satellite and the candidate satellites within the first time in the future;
determining, from the candidate satellites based on the predicted communication quality, a resource quantity of each of the candidate satellites, and the orbit data, networking satellites matching the satellite within the first time in the future, and constructing a satellite network of the satellite; and
sending the satellite network of the satellite to the satellite, whereby the satellite executes a distributed task in units of the satellite network.

2. The satellite network construction method according to claim 1, wherein the determining, from the candidate satellites based on the predicted communication quality, a resource quantity of each of the candidate satellites, and the orbit data, networking satellites matching the satellite within the first time in the future specifically comprises:
determining candidate links from links between the candidate satellites and the satellite based on the orbit data, and determining corresponding pheromone concentrations of the candidate links;
constructing, starting from the satellite, each satellite network of the satellite based on the corresponding pheromone concentrations of the candidate links, determining quality of each path, and adjusting the corresponding pheromone concentrations of the candidate links based on the determined quality of each path; and
after a preset quantity of rounds of adjustments, determining quality of each path in a current round, and determining the networking satellite of the satellite based on the quality of each path.

3. The satellite network construction method according to claim 2, wherein the adjusting the corresponding pheromone concentrations of the candidate links based on the determined quality of each path specifically comprises:
sorting each path based on the determined quality of each path to determine a first sequence;
determining a corresponding pheromone concentration of each path based on the corresponding pheromone concentrations of the candidate links in each path, and sorting each path based on each pheromone concentration to determine a second sequence; and
adjusting parameters of a preset pheromone concentration calculation formula with a goal of minimizing a difference between the first sequence and the second sequence, and updating the corresponding pheromone concentrations of the candidate links.

4. The satellite network construction method according to claim 2, wherein the determining candidate links from links between the candidate satellites and the satellite based on the orbit data specifically comprises:
determining evaluation scores of the links between the candidate satellites and the satellite based on the predicted communication quality, the resource quantity of each of the candidate satellites, and the orbit data; and
selecting a link whose evaluation score reaches a preset value as a candidate link.

5. The satellite network construction method according to claim 1, wherein the determining, based on orbit data of the satellite, other satellites capable of communicating with the satellite within first time in the future as candidate satellites of the satellite specifically comprises:
determining communicable satellites of the satellite based on the orbit data of the satellite; and
determining, based on communicable time periods of the communicable satellites, communicable satellites whose communication time periods overlap with a communication time period of the satellite within the first time in the future as candidate satellites of the satellite; and
the determining, from the candidate satellites, networking satellites matching the satellite within the first time in the future, and constructing a satellite network of the satellite specifically comprises:
determining, based on overlapping time periods between the satellite and the candidate satellites, networking satellites matching the satellite at each time point within the first time, and constructing a satellite network of the satellite at each time point within the first time.

6. The satellite network construction method according to claim 1, wherein the determining, from the candidate satellites, networking satellites matching the satellite within the first time in the future specifically comprises:
determining a quantity of communication terminals of the satellite; and
determining, from the candidate satellites, satellites whose quantity is not greater than the quantity of communication terminals as networking satellites of the satellite.

7. The satellite network construction method according to claim 1, wherein the sending the satellite network of the satellite to the satellite specifically comprises:
determining a satellite capable of communicating with the ground management platform at a current time point; and
sending each determined satellite network to the satellite capable of communicating with the ground management platform at the current time point, whereby the satellite capable of communicating with the ground management platform at the current time point performs inter-satellite synchronization on each satellite network.

8. A satellite network construction apparatus, wherein the satellite network construction apparatus is disposed on a ground management platform, and comprises:
a prediction module configured to: for a satellite in a satellite cluster, determine, based on orbit data of the satellite, other satellites capable of communicating with the satellite within first time in the future as candidate satellites of the satellite, and predict communication quality between the satellite and the candidate satellites within the first time in the future;
a construction module configured to determine, from the candidate satellites based on the predicted communication quality, a resource quantity of each of the candidate satellites, and the orbit data, networking satellites matching the satellite within the first time in the future, and construct a satellite network of the satellite; and
a sending module configured to send the satellite network of the satellite to the satellite, whereby the satellite executes a distributed task in units of the satellite network.

9. A computer-readable storage medium, storing a computer program, wherein the computer program is executed by a processor to implement the satellite network construction method according to claim 1.

10. A computer-readable storage medium, storing a computer program, wherein the computer program is executed by a processor to implement the satellite network construction method according to claim 2.

11. A computer-readable storage medium, storing a computer program, wherein the computer program is executed by a processor to implement the satellite network construction method according to claim 3.

12. A computer-readable storage medium, storing a computer program, wherein the computer program is executed by a processor to implement the satellite network construction method according to claim 4.

13. A computer-readable storage medium, storing a computer program, wherein the computer program is executed by a processor to implement the satellite network construction method according to claim 5.

14. A computer-readable storage medium, storing a computer program, wherein the computer program is executed by a processor to implement the satellite network construction method according to claim 6.

15. A computer-readable storage medium, storing a computer program, wherein the computer program is executed by a processor to implement the satellite network construction method according to claim 7.

16. An electronic device, comprising a memory, a processor, and a computer program stored in the memory and executable on the processor, wherein the processor executes the computer program to implement the satellite network construction method according to claim 1.

17. An electronic device, comprising a memory, a processor, and a computer program stored in the memory and executable on the processor, wherein the processor executes the computer program to implement the satellite network construction method according to claim 2.

18. An electronic device, comprising a memory, a processor, and a computer program stored in the memory and executable on the processor, wherein the processor executes the computer program to implement the satellite network construction method according to claim 3.

19. An electronic device, comprising a memory, a processor, and a computer program stored in the memory and executable on the processor, wherein the processor executes the computer program to implement the satellite network construction method according to claim 4.

20. An electronic device, comprising a memory, a processor, and a computer program stored in the memory and executable on the processor, wherein the processor executes the computer program to implement the satellite network construction method according to claim 5.

21. An electronic device, comprising a memory, a processor, and a computer program stored in the memory and executable on the processor, wherein the processor executes the computer program to implement the satellite network construction method according to claim 6.

22. An electronic device, comprising a memory, a processor, and a computer program stored in the memory and executable on the processor, wherein the processor executes the computer program to implement the satellite network construction method according to claim 7.
